(19) United States
(12) Patent Application Publication
(10) Pub. No.: US 2026/0259514 A1
(43) Pub. Date: Sep. 3, 2026

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: TAICHI SATO, Shizuoka (JP); YUKA ISHIDUKA, Shizuoka (JP); YUKI NAKANO, Shizuoka (JP); KUNIHIKO SEKIDO, Shizuoka (JP); AKIRA SAKAKIBARA, Shizuoka (JP)

(21) Appl. No.: 19/544,660

(22) Filed: Feb. 19, 2026

(30) Foreign Application Priority Data
Mar. 3, 2025 (JP) 2025-033148

(51) Int. Cl. G03G 5/05; G03G 5/06

(52) U.S. Cl. CPC G03G 5/056; G03G 5/0618; G03G 2215/00957; G03G 2215/00962; G03G 2221/183

(57) ABSTRACT

An electrophotographic photosensitive member includes a support and a photosensitive layer. The photosensitive layer contains a charge generation material, a binder resin, and a hole transport material. The binder resin contains a polyester resin having two different structural units. The hole transport material includes two different compounds.

### BACKGROUND

### Field of the Technology

The present disclosure relates to an electrophotographic photosensitive member, a process cartridge including the electrophotographic photosensitive member, and an electrophotographic apparatus including the electrophotographic photosensitive member.

### Description of the Related Art

In recent years, there has been a demand for an electrophotographic apparatus having a longer lifetime and capable of forming an image with higher image quality, and it is desirable to provide an apparatus that outputs an image with a highly stable image quality even after repeated use (hereinafter, also referred to as after endurance).

An organic electrophotographic photosensitive member containing an organic photoconductive substance (charge generation material) (hereinafter, also simply referred to as an “electrophotographic photosensitive member” or “photosensitive member”) is used as an electrophotographic photosensitive member to be mounted on an electrophotographic apparatus or a process cartridge installed in such an electrophotographic apparatus. In recent years, for electrophotographic apparatuses, techniques for improving endurance of various parts have been proposed in order to deal with the demand for a longer lifetime described above.

For example, Japanese Patent Laid-Open No. 2023-19706 proposes a photosensitive member in which a polyarylate resin (that is a type of polyester resin and may be represented as PAR), which has high wear resistance, is used as a binder resin contained in a photosensitive layer.

### SUMMARY

According to the examination conducted by the present inventors, it has been found that, in the electrophotographic photosensitive member described in Japanese Patent Laid-Open No. 2023-19706, an image failure called ghosting may occur.

The ghosting is the following phenomenon. For example, an image having a black background (black image) 12 in a white background (white image) 11 as illustrated in FIG. 1A is output in an image leading end portion, and a halftone image 13 of the similar knight jump pattern illustrated in FIG. 1B is subsequently output. At this time, in the halftone image 13 in the image illustrated in FIG. 1A, the image density in portions of the electrophotographic photosensitive member where the black background has been formed differs from that in peripheral portions, as illustrated in ghost portions 14.

The present disclosure is directed to providing an electrophotographic photosensitive member capable of reducing the occurrence of ghosting while having good wear resistance, a process cartridge including the electrophotographic photosensitive member, and an electrophotographic apparatus including the electrophotographic photosensitive member.

The present disclosure is as described below. Specifically, an electrophotographic photosensitive member according to the present disclosure includes a support and a photosensitive layer. The photosensitive layer contains a charge generation material, a binder resin, and a hole transport material. The binder resin contains a polyester resin having a structural unit represented by formula (P-1) and a structural unit represented by formula (P-2). The hole transport material includes a compound represented by formula (3) and a compound represented by formula (4).

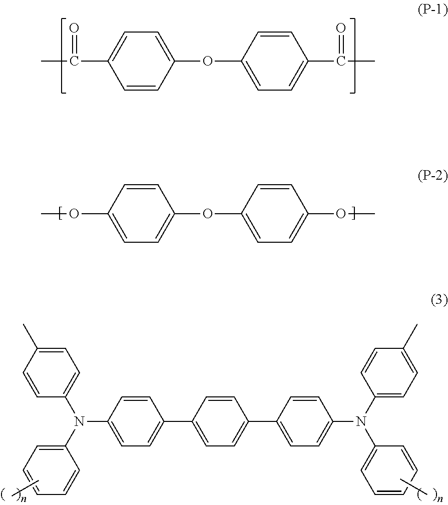

In formula (3), m and n each independently represent an integer of 0, 1, or 2.

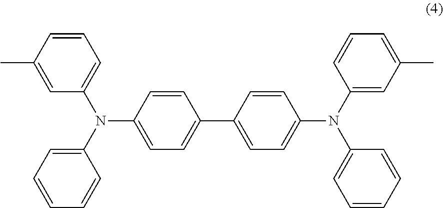

Features of the present disclosure will become apparent from the following description of embodiments with reference to the attached drawings. The following description of embodiments is described by way of example.

### BRIEF DESCRIPTION OF THE DRAWINGS

FIG. 1A is a view illustrating an example of an image for describing ghosting.

FIG. 1B is a view illustrating an example of an image for describing ghosting.

FIG. 2 is a view illustrating remaining of a hole in a photosensitive layer.

FIG. 3 includes views illustrating the mechanism of the occurrence of ghosting.

FIG. 4 is a view illustrating an example of the layer configuration of an electrophotographic photosensitive member.

FIG. 5 is a view illustrating an example of the layer configuration of an electrophotographic photosensitive member.

FIG. 6 is a view illustrating an example of the layer configuration of an electrophotographic photosensitive member.

FIG. 7 is a view illustrating an example of the schematic configuration of an electrophotographic apparatus.

FIG. 8 is a view illustrating an example of the schematic configuration of a process cartridge.

### DESCRIPTION OF THE EMBODIMENTS

It has been found that, in the electrophotographic photosensitive member described in Japanese Patent Laid-Open No. 2023-19706, the occurrence of ghosting cannot be sufficiently reduced. The present inventors infer the reason for this as follows.

To deal with large-volume printing and high-speed printing, high endurance is desired, and high hole mobility is also desired. Polyarylate resins, which achieve high wear resistance, have strong interaction between resins.

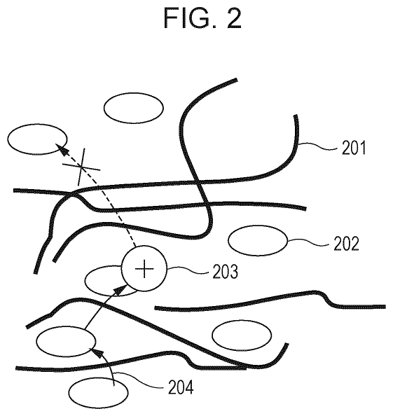

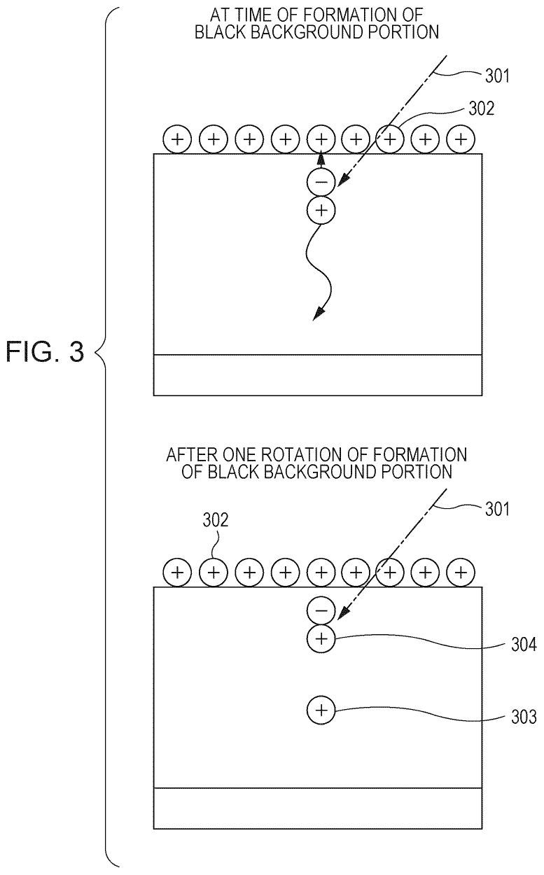

Meanwhile, to achieve high mobility, a hole transport material having an extended π electron conjugated system and a large size is used. While such a hole transport material has high hole mobility, the hole transport material cannot be present between resins that strongly interact with each other because of its large molecular size and tends to be in a nonuniform state. A hole 203 generated by exposure moves along hole transport materials 202 in a binder resin 201, as illustrated by arrows 204 in FIG. 2. However, if the hole transport materials 202 are in a nonuniform state and the distance between the hole transport materials 202 is large, the hole 203 cannot move and remains in a layer. As illustrated in FIG. 3, in a black background portion in which holes are likely to remain, movement of a hole 304 that is newly generated by exposure 301 is restricted by a remaining hole 303, and thus the newly generated hole 304 is more likely to recombine with an electron that is generated together. Electrons generated by exposure cancel out electric charges 302 on the surface of an electrophotographic photosensitive member, and the potential of the electrophotographic photosensitive member thereby decreases. However, since electrons are lost due to the recombination, the potential is less likely to decrease. Consequently, a potential difference is generated between such a portion and a portion in which holes do not remain, resulting in the occurrence of ghosting.

The present inventors have studied, on the basis of the above inference, various methods for reducing the occurrence of ghosting even in an electrophotographic photosensitive member in which a polyarylate resin, which has high wear resistance, is used as a binder resin contained in a photosensitive layer.

An electrophotographic photosensitive member according to the present disclosure includes a support and a photosensitive layer, in which the photosensitive layer contains a charge generation material, a binder resin, and a hole transport material, the binder resin contains a polyester resin having a structural unit represented by formula (P-1) below and a structural unit represented by formula (P-2) below, and the hole transport material includes a compound represented by formula (3) below and a compound represented by formula (4) below.

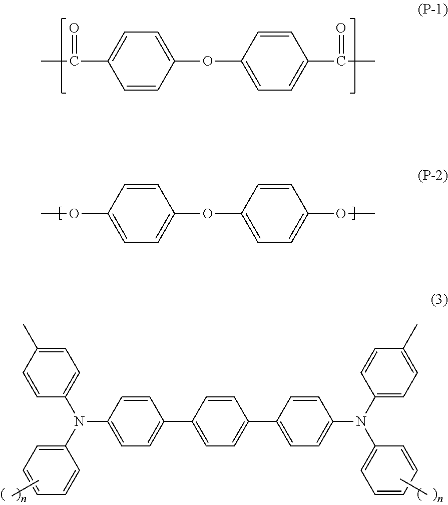

In formula (3), m and n each independently represent an integer of 0, 1, or 2.

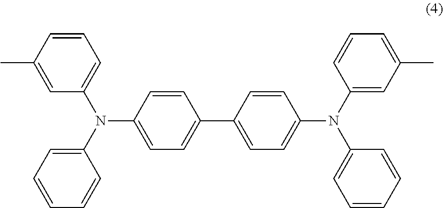

The mechanism by which the electrophotographic photosensitive member having the above configuration exhibits the effect of reducing the occurrence of ghosting is presumed as follows.

First, as described above, the polyester resin having a structural unit represented by formula (P-1) and a structural unit represented by formula (P-2) has strong interaction and high packing property. Therefore, the hole transport material having an extended π electron conjugated system and represented by formula (3) is less likely to be present in a region where such a polyester resin is packed. On the other hand, the hole transport material represented by formula (4) has a structure that coordinates easily to the structural unit represented by formula (P-1) and the structural unit represented by formula (P-2). Furthermore, since the hole transport material represented by formula (4) has a large excluded volume of the methyl groups with respect to the molecular motion, the hole transport material can also coordinate to the structural unit represented by formula (P-1) and the structural unit represented by formula (P-2) even in a region where such a polyester resin is packed. Since the hole transport material represented by formula (4) is present also in a region where the hole transport material represented by formula (3) is less likely to be present, a region where hole transport materials are absent is small. Thus, it is considered that the remaining of holes described above is less likely to occur, and the effect of reducing the occurrence of ghosting can be exhibited. Thus, wear resistance of the polyester resin and the reduction in the occurrence of ghosting can be combined.

It has also been found that after preparation of an electrophotographic photosensitive member, the sensitivity of the electrophotographic photosensitive member increases over a period of several tens of hours, suggesting that the above-described rearrangement of the hole transport material on the molecular level occurs. That is, the effect can be obtained regardless of the method for producing the electrophotographic photosensitive member.

As in the mechanism described above, the configurations exert a synergistic effect on each other to thereby achieve the effect.

The configuration of the electrophotographic photosensitive member will be described in more detail below.

### Electrophotographic Photosensitive Member

The electrophotographic photosensitive member according to the present disclosure includes a support and a photosensitive layer formed on the support.

The method for producing the electrophotographic photosensitive member may be a method of preparing coating liquids of layers described later, applying the coating liquids in the desired order of the layers, and drying the coating liquids. In this case, examples of the method of applying the coating liquids include dip coating, spray coating, ink jet coating, roll coating, die coating, blade coating, curtain coating, wire bar coating, and ring coating. Of these, dip coating is preferred from the viewpoint of efficiency and productivity.

### Single-Layer Photosensitive Member

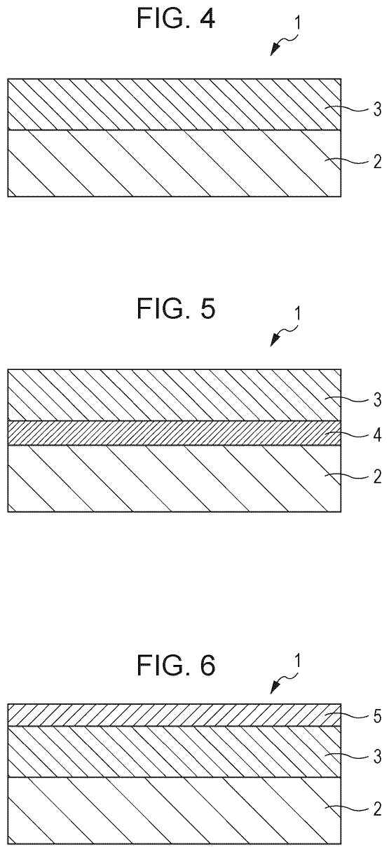

Hereinafter, a single-layer photosensitive member 1 according to an embodiment of the present disclosure will be described with reference to FIGS. 4 to 6. FIGS. 4 to 6 are each a partial sectional view illustrating an example of the layer configuration of the single-layer photosensitive member 1.

As illustrated in FIG. 4, the single-layer photosensitive member 1 includes, for example, a conductive support 2 and a photosensitive layer 3. The photosensitive layer 3 included in the single-layer photosensitive member 1 is a single-layer photosensitive layer composed of a single layer (one layer). The photosensitive layer 3 contains a binder resin, a charge generation material, an electron transport material, and a hole transport material.

As illustrated in FIG. 5, the single-layer photosensitive member 1 may further include an undercoat layer 4 (intermediate layer) in addition to the support 2 and the photosensitive layer 3. Specifically, in the single-layer photosensitive member 1, the photosensitive layer 3 may be disposed directly on the support 2 or may be disposed on the support 2 with the undercoat layer 4 interposed therebetween, as illustrated in FIG. 5.

As illustrated in FIG. 6, the single-layer photosensitive member 1 may further include a protective layer 5 in addition to the support 2 and the photosensitive layer 3. The protective layer 5 is disposed on the photosensitive layer 3. Preferably, as illustrated in FIGS. 4 and 5, the single-layer photosensitive member 1 does not include the protective layer 5, and the photosensitive layer 3 is disposed as a surface layer of the single-layer photosensitive member 1. When the photosensitive layer 3 containing, as the binder resin, a polyester resin having structural units represented by formula (P-1) and formula (P-2) is disposed as a surface layer, the effects according to the present disclosure are easily provided.

The thickness of the photosensitive layer 3 is not particularly limited but is preferably 5 μm or more and 100 μm or less, more preferably 10 μm or more and 50 μm or less.

### Support

The electrophotographic photosensitive member according to the present disclosure includes a support. The support is preferably a conductive support having conductivity. The shape of the support may be, for example, a cylindrical, belt-like, or sheet-like shape. In particular, the support is preferably a cylindrical support. The surface of the support may be subjected to an electrochemical treatment such as anodization, a blasting treatment, a cutting treatment, or the like.

The material of the support is preferably a metal, a resin, glass, or the like.

Examples of the metal include aluminum, iron, nickel, copper, gold, stainless steel, and alloys thereof. In particular, an aluminum support made of aluminum is preferred.

The resin and glass may be provided with conductivity by a treatment such as mixing or coating with a conductive material.

### Undercoat Layer

An undercoat layer may be disposed on the support or the conductive layer. When the undercoat layer is disposed, the adhesion function between the layers is enhanced, and a function of blocking charge injection can be imparted.

The undercoat layer preferably contains a resin. A composition containing a monomer having a polymerizable functional group may be polymerized to form a cured film serving as the undercoat layer.

Examples of the resin include polyester resins, polyarylate resins, polycarbonate resins, polyvinyl acetal resins, acrylic resins, epoxy resins, melamine resins, polyurethane resins, phenol resins, polyvinylphenol resins, alkyd resins, polyvinyl alcohol resins, polyethylene oxide resins, polypropylene oxide resins, polyamide resins, polyamic acid resins, polyimide resins, polyamide-imide resins, and cellulose resins.

For the monomer having a polymerizable functional group, the polymerizable functional group may be an isocyanate group, a blocked isocyanate group, a methylol group, an alkylated methylol group, an epoxy group, a metal alkoxide group, a hydroxyl group, an amino group, a carboxyl group, a thiol group, a carboxylic anhydride group, a carbon-carbon double bond group, or the like.

The undercoat layer may further contain, for example, an electron transport material, a metal oxide, a metal, or a conductive polymer in order to enhance electrical characteristics. Of these, an electron transport material and a metal oxide are preferably used.

Examples of the electron transport material include quinone compounds, imide compounds, benzimidazole compounds, cyclopentadienylidene compounds, fluorenone compounds, xanthone compounds, benzophenone compounds, cyanovinyl compounds, halogenated aryl compounds, silole compounds, and boron-containing compounds. An electron transport material having a polymerizable functional group may be used as the electron transport material and copolymerized with the above-described monomer having a polymerizable functional group to form a cured film serving as the undercoat layer.

Examples of the metal oxide include indium tin oxide, tin oxide, indium oxide, titanium oxide, zinc oxide, aluminum oxide, and silicon dioxide. Examples of the metal include gold, silver, and aluminum.

The undercoat layer may further contain an additive.

The undercoat layer has an average thickness of preferably 0.1 μm or more and 50 μm or less, more preferably 0.2 μm or more and 40 μm or less, particularly preferably 0.3 μm or more and 30 μm or less.

The undercoat layer can be formed by preparing an undercoat layer-forming coating liquid containing the above materials and a solvent, forming a coating film of the coating liquid, and drying and/or curing the coating film. Examples of the solvent used for the coating liquid include alcohol solvents, ketone solvents, ether solvents, ester solvents, and aromatic hydrocarbon solvents.

### Single-Layer Photosensitive Layer

The electrophotographic photosensitive member according to the present disclosure includes a single-layer photosensitive layer on the support or the undercoat layer disposed on the support.

The single-layer photosensitive layer contains a binder resin, a charge generation material, a hole transport material, and an electron transport material.

### Binder Resin

The binder resin used for the photosensitive layer contains a polyester resin having a structural unit represented by formula (P-1) below and a structural unit represented by formula (P-2) below.

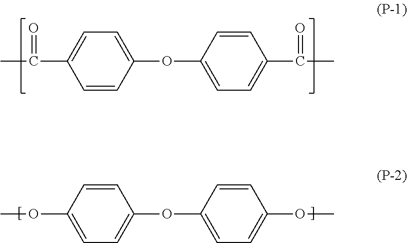

The binder resin used for the photosensitive layer preferably has a structural unit represented by formula (P-3) below from the viewpoint of improving sensitivity.

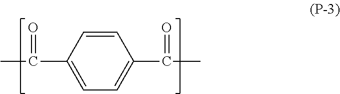

Furthermore, the binder resin used for the photosensitive layer preferably has a structural unit represented by formula (P-4) below from the viewpoints of solubility in a solvent and bleeding of a low-molecular weight component.

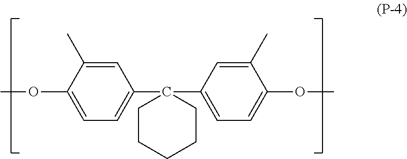

The molecular structures of the chemical substances can be determined using a nuclear magnetic resonance (NMR) apparatus.

The polyester resin may be, for example, a random copolymer, an alternating copolymer, a periodic copolymer, or a block copolymer.

In the polyester resin, a ratio of the amount of substance of the structural unit represented by formula (P-1) to the total amount of substance of the structural units constituting the polyester resin is defined as M1. A ratio of the amount of substance of the structural unit represented by formula (P-2) to the total amount of substance of the structural units constituting the polyester resin is defined as M2. A ratio of the amount of substance of the structural unit represented by formula (P-3) to the total amount of substance of the structural units constituting the polyester resin is defined as M3. A ratio of the amount of substance of the structural unit represented by formula (P-4) to the total amount of substance of the structural units constituting the polyester resin is defined as M4. In this case, a ratio M1/(M1+M3) is preferably more than 0.30, more preferably 0.55 or more from the viewpoint of improving wear resistance.

A ratio M2/(M2+M4) is preferably large from the viewpoint of improving wear resistance and, specifically, is preferably 0.10 or more. From the viewpoint of solubility in a solvent, the ratio M2/(M2+M4) is preferably less than 0.50. The improvement in solubility in a solvent enables the photosensitive layer to be satisfactorily formed. Accordingly, the ratio M2/(M2+M4) is preferably 0.10 or more and less than 0.50.

A ratio M3/(M1+M3) is preferably 0.30 or more and less than 0.70 from the viewpoint of suppressing a decrease in sensitivity.

A ratio M4/(M2+M4) is preferably less than 0.90 from the viewpoint of improving solubility in a solvent.

In a case where the total amount of substance of a structural unit represented by formula (a) below and constituting the polyester resin is defined as MC, and the amount of substance of the structural unit represented by formula (P-1) is defined as M1, 0.90≥M1/MC≥0.50 is preferably satisfied, and 0.90≥M1/MC≥0.70 is more preferably satisfied.

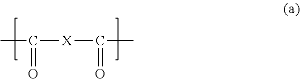

In formula (a), X represents a divalent organic group.

In the polyester resin, in a case where the total amount of substance of the structural unit represented by formula (a) and constituting the polyester resin is defined as MC, the amount of substance of the structural unit represented by formula (P-1) is defined as M1, and the amount of substance of the structural unit represented by formula (P-3) is defined as M3, a ratio (M1+M3)/MC is preferably 0.50 or more.

In the polyester resin, in a case where the total amount of substance of bisphenol-derived structural units constituting the polyester resin is defined as MB, the amount of substance of the structural unit represented by formula (P-2) is defined as M2, and the amount of substance of the structural unit represented by formula (P-4) is defined as M4, a ratio (M2+M4)/MB is preferably 0.5 or more.

Examples of bisphenols for constituting the bisphenol-derived structural units in the polyester resin include a compound represented by formula (BP-1) below and a compound represented by formula (BP-2) below. Hereinafter, the compound represented by formula (BP-1) below may be referred to as the compound (BP-1), and the compound represented by formula (BP-2) below may be referred to as the compound (BP-2).

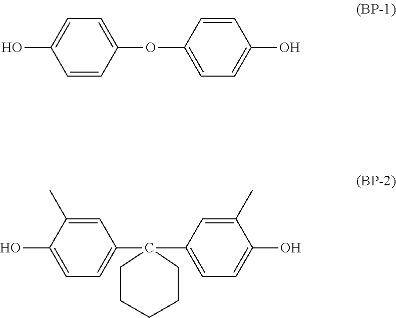 [SMILES: Oc1ccc(Oc2ccc(O)cc2)cc1 ; Cc1cc(C2(c3ccc(O)c(C)c3)CCCCC2)ccc1O]

Examples of dicarboxylic acids for constituting dicarboxylic acid-derived structural units in the polyester resin include a compound represented by formula (DC-1) below and a compound represented by formula (DC-2) below. Hereinafter, the compound represented by formula (DC-1) below may be referred to as the compound (DC-1), and the compound represented by formula (DC-2) below may be referred to as the compound (DC-2).

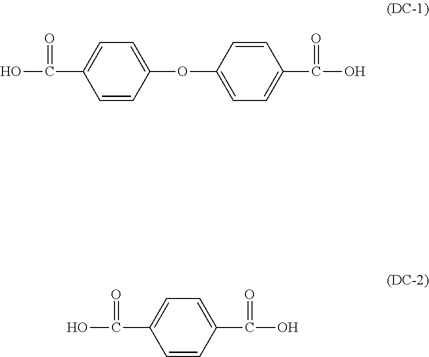 [SMILES: O=C(O)c1ccc(Oc2ccc(C(=O)O)cc2)cc1 ; O=C(O)c1ccc(C(=O)O)cc1]

The ratio of bisphenols in the resin can be adjusted by changing the amount of the compound (BP-1) and the amount of the compound (BP-2) added in the production of the polyester resin. Similarly, the ratio of dicarboxylic acids in the resin can be adjusted by changing the amount of the compound (DC-1) and the amount of the compound (DC-2) added in the production of the polyester resin.

The bisphenols (for example, the compound (BP-1) and the compound (BP-2)) may be derivatized to aromatic diacetates and used. The dicarboxylic acids (for example, the compound (DC-1) and the compound (DC-2)) may be derivatized and used. Examples of the derivatives of the dicarboxylic acids include dicarboxylic acid dichlorides, dicarboxylic dimethyl esters, dicarboxylic diethyl esters, and dicarboxylic anhydrides. The dicarboxylic acid dichlorides are compounds having a structure in which the two “—C(═O)—OH” groups of a dicarboxylic acid are each substituted with a “—C(═O)—Cl” group.

In condensation polymerization of a bisphenol and a dicarboxylic acid, one or both of a base and a catalyst may be added. Examples of the base include sodium hydroxide. Examples of the catalyst include benzyltributylammonium chloride, ammonium chloride, ammonium bromide, quaternary ammonium salts, triethylamine, and trimethylamine.

The photosensitive layer may contain, as the binder resin, the polyester resin alone or may further contain a binder resin other than this (hereinafter, also referred to as the other binder resin). When the photosensitive layer contains the other binder resin in addition to the polyester resin, the ratio of the mass of the polyester resin to the total mass of the binder resin in the photosensitive layer is preferably 0.50 or more, more preferably 0.80 or more.

Examples of the other binder resin include thermoplastic resins (more specifically, polyester resins other than the above-described polyester resins, polyarylate resins, polycarbonate resins, styrene-based resins, styrene-butadiene copolymers, styrene-acrylonitrile copolymers, styrene-maleic acid copolymers, styrene-acrylic acid copolymers, acrylic copolymers, polyethylene resins, ethylene-vinyl acetate copolymers, chlorinated polyethylene resins, polyvinyl chloride resins, polypropylene resins, ionomers, vinyl chloride-vinyl acetate copolymers, polyester resins, alkyd resins, polyamide resins, polyurethane resins, polysulfone resins, diallyl phthalate resins, ketone resins, polyvinyl butyral resins, polyvinyl acetal resins, and polyether resins), thermosetting resins (more specifically, silicone resins, epoxy resins, phenol resins, urea resins, melamine resins, and other crosslinkable thermosetting resins), and photocurable resins (more specifically, epoxy-acrylic acid-based resins, and urethane-acrylic acid-based copolymers).

The structure of the polyarylate resin can be determined from the ¹H-nuclear magnetic resonance spectrum obtained by subjecting the polymer component recovered from the photosensitive layer to ¹H-nuclear magnetic resonance analysis in deuterated chloroform.

An example of a specific analytical method for the polyarylate resin in a photosensitive layer when the photosensitive member is a cylindrical body will be described below.

### Reprecipitation of Resin in Photosensitive Layer

The photosensitive member is cut at a position 10 cm from an end of the photosensitive member in the generatrix direction using a fretsaw.
The inner surface of the cut 10 cm cylindrical body is wiped with lens-cleaning paper impregnated with chloroform.
In order to dissolve the photosensitive layer, a 3 cm end portion of the cut cylindrical body is immersed in chloroform.
   (About 60 mL of chloroform is placed in a 100 mL beaker, and the end portion is immersed therein at room temperature for five minutes.)
The chloroform solution in which the photosensitive layer has been dissolved is concentrated using a rotary evaporator to a volume of 2 mL, and the concentration is stopped.
A methanol/acetone mixed solution (volume ratio of 1:1, 50 mL) is prepared, and the resulting concentrated solution is entirely added dropwise under stirring to perform reprecipitation.
Suction filtration is performed using a funnel (funnel: SU-40, filter paper: No. 5C-40, both are manufactured by Kiriyama Glass Works Co.).
The residue on the filter paper is collected with a spatula and vacuum-dried (at 70° C. for one hour).

### NMR Measurement

In order to prepare a measurement sample, 20 mg of the sample is dissolved in 1 g of deuterated chloroform containing tetramethylsilane serving as the reference material, and the entire amount of the solution is transferred to an NMR tube. (deuterated chloroform: chloroform-d, product number: 612200, manufactured by Sigma-Aldrich Japan K.K.)
   (NMR tube: ST500-7, product number: S3010, manufactured by Norell Inc.)
NMR measurement is performed.
   Apparatus: AVANCE500, manufactured by Bruker Corporation
   Conditions: proton NMR, automatic measurement using ICON-NMR
   Number of scans: 32 times
   Reference peak: The methyl group peak of tetramethylsilane is set to 0 ppm.

### Hole Transport Material

The hole transport material includes a compound represented by formula (3) below and a compound represented by formula (4) below.

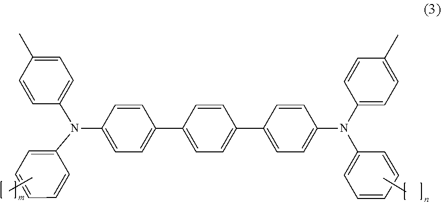

In formula (3), m and n each independently represent an integer of 0, 1, or 2.

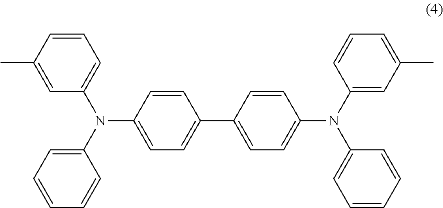

A preferred example of the compound represented by formula (3) may be a compound (H-1) shown below from the viewpoint of solubility when a coating liquid is prepared. Hereinafter, the compound represented by formula (H-1) may be referred to as the hole transport material (H-1), and the compound represented by formula (4) may be referred to as the hole transport material (H-2).

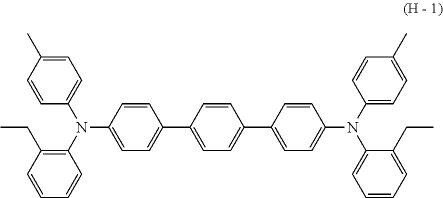 [SMILES: CCc1ccccc1N(c1ccc(C)cc1)c1ccc(-c2ccc(-c3ccc(N(c4ccc(C)cc4)c4ccccc4CC)cc3)cc2)cc1]

The ¹H-NMR spectra of the compounds represented by formulas (3) and (4) can be obtained by ¹H-nuclear magnetic resonance analysis in a solvent such as deuterated chloroform. This enables the structures represented by formulas (3) and (4) to be identified.

When the content of the binder resin is 100 parts by mass, the content of the hole transport material in the photosensitive layer is preferably 10 parts by mass or more and 200 parts by mass or less relative to 100 parts by mass of the binder resin. If the content of the hole transport material is 10 parts by mass or less, the sensitivity decreases, and the residual potential also increases. If the content of the hole transport material is 200 parts by mass or more, wear resistance deteriorates. The content of the hole transport material is more preferably 30 parts by mass or more and 120 parts by mass or less, still more preferably 50 parts by mass or more and 90 parts by mass or less.

A ratio of the content of the hole transport material represented by formula (4) in the photosensitive layer to the content of the hole transport material represented by formula (3) in the photosensitive layer is preferably 0.05 or more and 0.50 or less. This is because, if the ratio is less than 0.05, the effect of reducing the occurrence of ghosting decreases, and if the ratio exceeds 0.50, wear resistance deteriorates. The ratio is more preferably 0.10 or more and 0.30 or less.

The photosensitive layer may further contain at least one hole transport material other than the compounds represented by formulas (3) and (4) (hereinafter, may be referred to as the other hole transport material). Examples of the other hole transport material include triphenylamine derivatives, diamine derivatives (such as N,N,N′,N′-tetraphenylbenzidine derivatives, N,N,N′,N′-tetraphenylphenylenediamine derivatives, N,N,N′,N′-tetraphenylnaphthylenediamine derivatives, N,N,N′,N′-tetraphenylphenanthrylenediamine derivatives, and di(aminophenylethenyl)benzene derivatives), oxadiazole-based compounds (such as 2,5-di(4-methylaminophenyl)-1,3,4-oxadiazole), styryl-based compounds (such as 9-(4-diethylaminostyryl)anthracene), carbazole-based compounds (such as polyvinylcarbazole), organic polysilane compounds, pyrazoline-based compounds (such as 1-phenyl-3-(p-dimethylaminophenyl)pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds.

In the photosensitive layer, a ratio of the total amount of substance of the compound represented by formula (3) and the compound represented by formula (4) to the total amount of substance of all the hole transport materials contained in the photosensitive layer is preferably 0.6 or more, more preferably 0.8 or more.

### Charge Generation Material

Examples of the charge generation material include phthalocyanine-based pigments, perylene-based pigments, bisazo pigments, trisazo pigments, dithioketopyrrolopyrrole pigments, metal-free naphthalocyanine pigments, metal naphthalocyanine pigments, squaraine pigments, indigo pigments, azulenium pigments, cyanine pigments, powders of inorganic photoconductive materials (such as selenium, selenium-tellurium, selenium-arsenic, cadmium sulfide, and amorphous silicon), pyrylium pigments, anthanthrone-based pigments, triphenylmethane-based pigments, threne-based pigments, toluidine-based pigments, pyrazoline-based pigments, and quinacridone-based pigments. The photosensitive layer may contain a single charge generation material alone or two or more charge generation materials.

The phthalocyanine-based pigments are pigments having a phthalocyanine structure. Examples of the phthalocyanine-based pigments include metal-free phthalocyanines and metal phthalocyanines.

Examples of the metal phthalocyanines include titanyl phthalocyanine, hydroxygallium phthalocyanine, and chlorogallium phthalocyanine. Such a metal phthalocyanine is preferably titanyl phthalocyanine. Titanyl phthalocyanine is represented by formula (CGM-1) below.

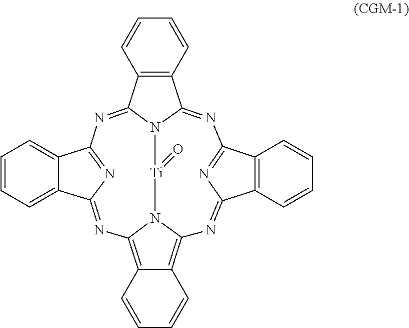

The phthalocyanine-based pigments may be crystalline or amorphous. Examples of the crystals of the metal-free phthalocyanines include X-type crystals of metal-free phthalocyanines (hereinafter, may be referred to as X-type metal-free phthalocyanines). Examples of the crystals of titanyl phthalocyanine include α-type, β-type, and Y-type crystals of titanyl phthalocyanine (hereinafter, may be referred to as α-type, β-type, and Y-type titanyl phthalocyanines, respectively).

For example, for a digital optical electrophotographic apparatus (for example, a laser beam printer or a facsimile using a light source such as a semiconductor laser), a photosensitive member having sensitivity in a wavelength region of 700 nm or more is preferably used. The charge generation material is preferably a phthalocyanine-based pigment, more preferably a metal-free phthalocyanine or titanyl phthalocyanine because such a phthalocyanine has a high quantum yield in the wavelength region of 700 nm or more. The charge generation material is still more preferably titanyl phthalocyanine, particularly preferably Y-type titanyl phthalocyanine.

In a CuKα characteristic X-ray diffraction spectrum, Y-type titanyl phthalocyanine has no peak at 26.2° but has a main peak at, for example, a Bragg angle (2θ+0.2°) of 27.2°. The main peak in a CuKα characteristic X-ray diffraction spectrum is a peak having the highest or second highest intensity in a Bragg angle range (2θ+0.2°) of 3° or more and 40° or less.

The CuKα characteristic X-ray diffraction spectrum can be measured by, for example, the following method. First, a sample (titanyl phthalocyanine) is packed in a sample holder of an X-ray diffractometer (XRD) (for example, “RINT (registered trademark) 1100” manufactured by Rigaku Holdings Corporation). Subsequently, the X-ray diffraction spectrum is measured under conditions of an X-ray tube of Cu, a tube voltage of 40 kV, a tube current of 30 mA, and a CuKα characteristic X-ray having a wavelength of 1.542 Å. The measurement range (2θ) is, for example, 3° or more and 40° or less (start angle: 3°, stop angle: 40°), and the scanning rate is, for example, 10°/min. The main peak is determined from the obtained X-ray diffraction spectrum, and the Bragg angle of the main peak is read.

When the content of the binder resin is 100 parts by mass, the content of the charge generation material in the photosensitive layer is preferably 0.1 parts by mass or more and 50 parts by mass or less, more preferably 0.5 parts by mass or more and 15 parts by mass or less relative to 100 parts by mass of the content of the binder resin.

### Electron Transport Material

The electron transport material preferably includes at least one compound selected from the group consisting of the compound represented by formula (7) below, the compound represented by formula (8) below, the compound represented by formula (9) below, the compound represented by formula (10) below, the compound represented by formula (11) below, the compound represented by formula (12) below, and the compound represented by formula (13) below.

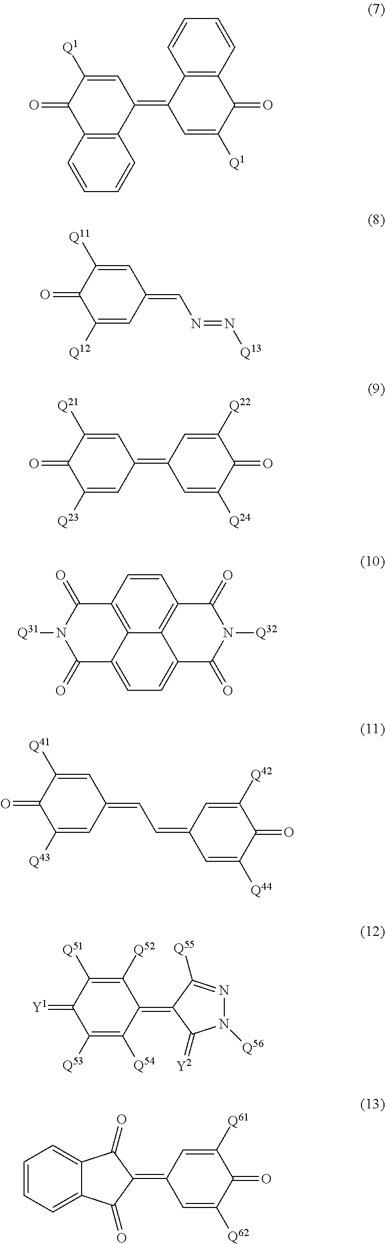

Q¹ and Q² in formula (7), Q¹¹, Q¹², and Q¹³ in formula (8), Q²¹, Q²², Q²³, and Q²⁴ in formula (9), Q³¹ and Q³² in formula (10), Q⁴¹, Q⁴², Q⁴³, and Q⁴⁴ in formula (11), Q⁵¹, Q⁵², Q⁵³, Q⁵⁴, Q⁵⁵, and Q⁵⁶ in formula (12), and Q⁶¹ and Q⁶² in formula (13) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group that has 6 or more and 14 or less carbon atoms and that may be substituted with at least one substituent selected from the group consisting of alkyl groups having 1 or more and 6 or less carbon atoms and halogen atoms. In formula (12), Y¹ and Y² each independently represent an oxygen atom or a sulfur atom.

Q¹ and Q² in formula (7), Q¹¹ to Q¹³ in formula (8), Q²¹ to Q²⁴ in formula (9), Q³¹ and Q³² in formula (10), Q⁴¹ to Q⁴⁴ in formula (11), Q⁵¹ to Q⁵⁶ in formula (12), and Q⁶¹ and Q⁶² in formula (13) each independently represent preferably a hydrogen atom, an alkyl group having 1 or more and 6 or less carbon atoms, or an aryl group that has 6 or more and 14 or less carbon atoms and that may be substituted with at least one substituent selected from the group consisting of alkyl groups having 1 or more and 6 or less carbon atoms and halogen atoms. In formula (12), Y¹ and Y² preferably represent an oxygen atom.

The alkyl group having 1 or more and 6 or less carbon atoms and represented by Q¹ and Q² in formula (7), Q¹¹ to Q¹³ in formula (8), Q²¹ to Q²⁴ in formula (9), Q³¹ and Q³² in formula (10), Q⁴¹ to Q⁴⁴ in formula (11), Q⁵¹ to Q⁵⁶ in formula (12), and Q⁶¹ and Q⁶² in formula (13) is preferably an alkyl group having 1 or more and 5 or less carbon atoms, preferably a methyl group, an ethyl group, a propyl group, a butyl group, or a pentyl group, particularly preferably a methyl group, an isopropyl group, a tert-butyl group, or a 1,1-dimethylpropyl group.

The aryl group having 6 or more and 14 or less carbon atoms and represented by Q¹ and Q² in formula (7), Q¹¹ to Q¹³ in formula (8), Q²¹ to Q²⁴ in formula (9), Q³¹ and Q³² in formula (10), Q⁴¹ to Q⁴⁴ in formula (11), Q⁵¹ to Q⁵⁶ in formula (12), and Q⁶¹ and Q⁶² in formula (13) is preferably an aryl group having 6 or more and 10 or less carbon atoms, more preferably a phenyl group.

Here, such an alkyl group that has 1 or more and 6 or less carbon atoms and that the aryl group having 6 or more and 14 or less carbon atoms may have as a substituent is preferably an alkyl group having 1 or more and 3 or less carbon atoms, more preferably a methyl group or an ethyl group.

Such a halogen atom that the aryl group having 6 or more and 14 or less carbon atoms may have as a substituent is preferably a fluorine atom, a chlorine atom, or a bromine atom, particularly preferably a chlorine atom.

When the aryl group having 6 or more and 14 or less carbon atoms is substituted with a substituent, the number of substituents is preferably 1 or more and 5 or less, more preferably 1 or 2.

The aryl group having 6 or more and 14 or less carbon atoms and substituted with at least one substituent selected from the group consisting of alkyl groups having 1 or more and 6 or less carbon atoms and halogen atoms is preferably a chlorophenyl group, a dichlorophenyl group, or an ethylmethylphenyl group, more preferably a 4-chlorophenyl group, a 2,5-dichlorophenyl group, or a 2-ethyl-6-methylphenyl group.

Preferred examples of the compound represented by formula (7) include the compound represented by formula (E-4) below. Preferred examples of the compound represented by formula (8) include the compound represented by formula (E-5) below. Preferred examples of the compound represented by formula (9) include the compound represented by formula (E-7) below. Preferred examples of the compound represented by formula (10) include the compound represented by formula (E-6) below. Preferred examples of the compound represented by formula (11) include the compound represented by formula (E-8) below. Preferred examples of the compound represented by formula (12) include the compound represented by formula (E-2) below and the compound represented by formula (E-3) below. Preferred examples of the compound represented by formula (13) include the compound represented by formula (E-1) below. Hereinafter, the compounds represented by formulas (E-1) to (E-8) may be referred to as the electron transport materials (E-1) to (E-8), respectively.

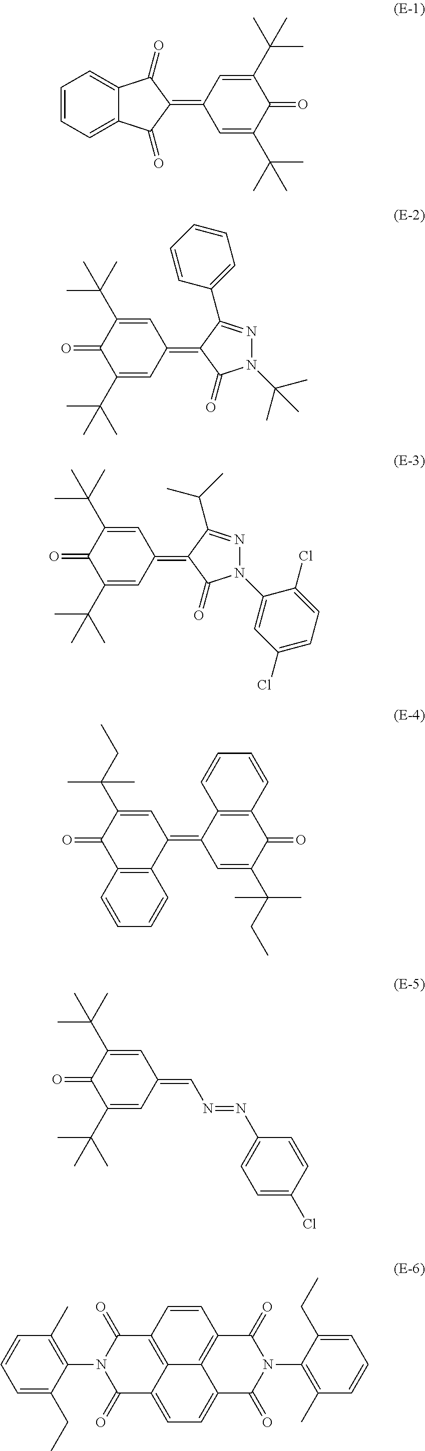

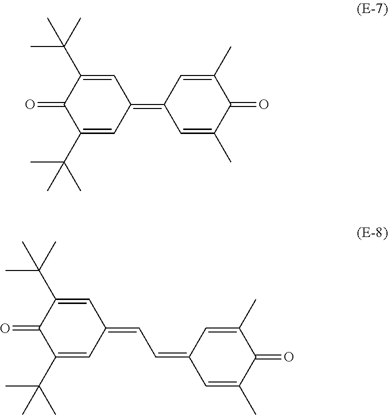 [SMILES: CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O]

When the content of the binder resin is 100 parts by mass, the content of the electron transport material in the photosensitive layer is preferably 5 parts by mass or more and 150 parts by mass or less relative to 100 parts by mass of the content of the binder resin. The content of the electron transport material is more preferably 10 parts by mass or more and 100 parts by mass or less, still more preferably 30 parts by mass or more and 70 parts by mass or less. The photosensitive layer may contain a single electron transport material alone or two or more electron transport materials.

### Additive

The photosensitive layer may contain an additive as necessary. Examples of the additive include ultraviolet absorbers, antioxidants, radical scavengers, singlet quenchers, softeners, surface modifiers, extenders, thickeners, waxes, donors, surfactants, plasticizers, sensitizers, and leveling agents. In particular, the photosensitive layer preferably contains at least one compound selected from the group consisting of the compound represented by formula (T-1) below, the compound represented by formula (T-2) below, the compound represented by formula (T-3) below, and the compound represented by formula (T-4) below. Note that t-Bu in formulas (T-2), (T-3), and (T-4) represents a tert-butyl group.

The content of the additive in the photosensitive layer is preferably 0.1% by mass or more and 10% by mass or less relative to the total mass of the photosensitive layer.

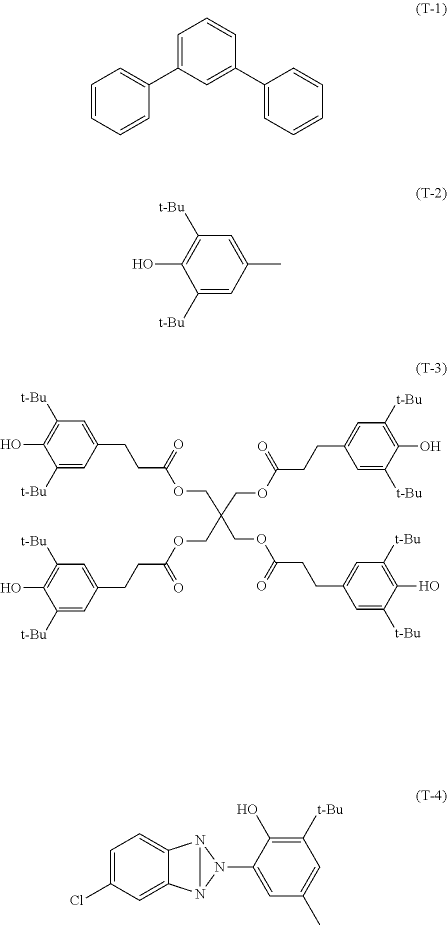

Next, a process cartridge and an electrophotographic apparatus will be described.

The process cartridge includes the above-described electrophotographic photosensitive member, and at least one unit selected from the group consisting of a charging unit, an exposure unit, a developing unit, and a cleaning unit, the process cartridge integrally supporting the electrophotographic photosensitive member and the at least one unit and being attachable to and detachable from a main body of an electrophotographic apparatus.

The electrophotographic apparatus includes the above-described electrophotographic photosensitive member, a charging unit, an exposure unit, a developing unit, and a transfer unit.

The charging unit may be a charging unit configured to positively charge the electrophotographic photosensitive member.

### Electrophotographic Apparatus

An example of the configuration of an electrophotographic apparatus will be described in detail below.

The electrophotographic apparatus includes the above-described electrophotographic photosensitive member, a charging unit, an exposure unit, a developing unit, and a transfer unit. The charging unit charges the surface of the electrophotographic photosensitive member. The exposure unit irradiates the charged surface of the photosensitive member with light to form an electrostatic latent image on the surface of the photosensitive member. The developing unit includes a toner, and develops the electrostatic latent image formed on the surface of the photosensitive member using the toner to form a toner image on the surface of the photosensitive member. The developing unit is a developing roller.

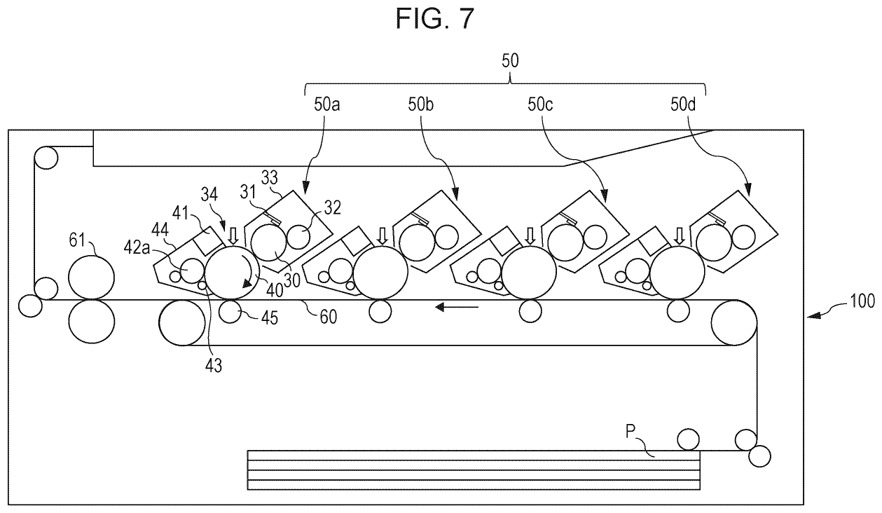

A tandem-system color electrophotographic apparatus illustrated in FIG. 7 will be described as an example.

An electrophotographic apparatus 100 illustrated in FIG. 7 includes image-forming units 50a, 50b, 50c, and 50d, a transfer belt 60, and a fixing device 61. Hereinafter, the image-forming units 50a, 50b, 50c, and 50d will each be referred to as an image-forming unit 50 when it is not necessary to distinguish between them. The image-forming unit 50 includes an electrophotographic photosensitive member 40, a charging device 41 serving as the charging unit, an exposure device 34 serving as the exposure unit, a developing device 33 serving as the developing unit, and a transfer device 45 serving as the transfer unit. The electrophotographic photosensitive member 40 is an electrophotographic photosensitive member. A recording medium P is disposed in a lower portion of the electrophotographic apparatus. At a central position of the image-forming unit 50, the electrophotographic photosensitive member 40 is disposed. The electrophotographic photosensitive member 40 is disposed so as to be rotatable in the arrow direction (clockwise direction in FIG. 7). Around the electrophotographic photosensitive member 40, the charging device 41, the exposure device 34, the developing device 33, and the transfer device 45 are disposed in this order from the upstream side in the rotational direction of the electrophotographic photosensitive member 40.

The image-forming units 50a to 50d successively superimpose toner images of a plurality of colors (for example, four colors of black, cyan, magenta, and yellow) on the recording medium P on the transfer belt 60. The charging device 41 charges the surface (for example, the circumferential surface) of the electrophotographic photosensitive member 40 to a positive polarity. The charging device 41 is, for example, a charging roller. The exposure device 34 irradiates the charged surface of the electrophotographic photosensitive member 40 with exposure light. That is, the exposure device 34 exposes the charged surface of the electrophotographic photosensitive member 40. Thus, an electrostatic latent image is formed on the surface of the electrophotographic photosensitive member 40. The electrostatic latent image is formed on the basis of the image data input to the electrophotographic apparatus 100. The developing device 33 includes a toner, supplies the toner to the surface of the electrophotographic photosensitive member 40, and develops the electrostatic latent image to form a toner image.

The developing device 33 (for example, the surface of the developing device 33, more specifically, the circumferential surface of the developing device 33) is in contact with the surface of the electrophotographic photosensitive member 40. That is, the electrophotographic apparatus 100 employs the contact developing system. The developing device 33 is, for example, a developing roller. When the developer is a single-component developer, the developing device 33 supplies the toner that is the single-component developer to the electrostatic latent image formed on the electrophotographic photosensitive member 40. When the developer is a two-component developer, the developing device 33 supplies the toner out of the toner and the carrier contained in the two-component developer to the electrostatic latent image formed on the electrophotographic photosensitive member 40.

In the developing unit, a developer having an average circularity of 0.960 or less or having an average circularity of 0.975 or more is preferably used. When the average circularity is 0.960 or less, the cleaning property is improved. When the average circularity is 0.975 or more, the transfer efficiency to a member to be transferred is improved. The average circularity of the toner can be controlled by adjusting production conditions.

The average circularity of the toner is measured and analyzed using a flow-type particle image analyzer “FPIA-3000” (manufactured by Sysmex Corporation) under the following conditions.

The measurement principle of the flow-type particle image analyzer “FPIA-3000” (manufactured by Sysmex Corporation) is to take images of flowing particles as still images and perform image analysis. A sample added to a sample chamber is delivered to a flat sheath flow cell with a sample suction syringe. The sample delivered to the flat sheath flow cell forms a flat flow by being surrounded by a sheath liquid.

The sample passing through the inside of the flat sheath flow cell is irradiated with strobe light at 1/60 second intervals, so that flowing particles can be photographed as still images. In addition, since the flow is flat, the images are taken in a focused state. The particle images are taken with a CCD camera, and the taken images are subjected to image processing at an image processing resolution of 512×512 pixels (0.37×0.37 μm per pixel). The contour of each particle image is extracted, and, for example, the projected area S and the perimeter L of the particle image are measured.

Next, the circle-equivalent diameter and the circularity are determined using the projected area S and the perimeter L. The circle-equivalent diameter is the diameter of a circle having the same area as the projected area of the particle image. The circularity C is defined as the value obtained by dividing the perimeter of a circle determined from the circle-equivalent diameter by the perimeter of a particle projection image and is calculated by the following equation.

$$Circularity C = 2 \times {( π \times S )}^{1 / 2} / L$$

When the particle image is a circle, the circularity is 1.000. The value of circularity decreases with an increase in the degree of unevenness of the outer periphery of the particle image. The circularity of each particle is calculated, a circularity range of 0.200 to 1.000 is then divided into 800, and the arithmetic mean value of the resulting circularities is calculated as the average circularity.

Specifically, the measurement method is as follows. First, 20 mL of deionized water from which impurity solids and the like have been removed in advance is placed in a glass container. To the container, 0.2 mL of a dilution of “Contaminon N” (a 10 mass % aqueous solution of neutral detergent for washing precision measuring instruments, containing a nonionic surfactant, an anionic surfactant, and an organic builder and having a pH of 7, manufactured by FUJIFILM Wako Pure Chemical Corporation) diluted 3-fold by mass with deionized water is added as a dispersing agent.

In the measurement, the flow-type particle image analyzer equipped with a standard objective lens (10×) is used, and a particle sheath “PSE-900A” (manufactured by Sysmex Corporation) is used as a sheath liquid. The dispersion liquid prepared in accordance with the above procedure is introduced into the flow-type particle image analyzer, and 3,000 toner particles are measured in a total count mode of an HPF measurement mode. Subsequently, the binarization threshold at the time of particle analysis is set to 85%, and the particle diameter to be analyzed is limited to a circle-equivalent diameter of 1.985 μm or more and less than 39.69 μm to determine the average circularity of the toner particles.

In the measurement, automatic focusing is performed before the start of the measurement using standard latex particles. For example, “RESEARCH AND TEST PARTICLES Latex Microsphere Suspensions 5200A” manufactured by Duke Scientific Corporation are diluted with deionized water and used. Subsequently, focusing is preferably performed every two hours from the start of the measurement.

Thus, the electrophotographic photosensitive member 40 carries the toner image. The transfer belt 60 conveys the recording medium P to the gap between the electrophotographic photosensitive member 40 and the transfer device 45. The transfer belt 60 is an endless belt. The transfer belt 60 is disposed so as to be rotatable in the arrow direction (counterclockwise direction in the figure). The transfer device 45 transfers the toner image developed by the developing device 33, from the surface of the electrophotographic photosensitive member 40 to a member to be transferred. The member to be transferred is the recording medium P. When the toner image is transferred, the electrophotographic photosensitive member 40 is in contact with the recording medium P. Specifically, the electrophotographic apparatus 100 employs the direct transfer system. The transfer device 45 is, for example, a transfer roller. The recording medium P to which the toner image has been transferred by the transfer device 45 is conveyed to the fixing device 61 by the transfer belt 60. The fixing device 61 is, for example, a heating roller and/or a pressing roller. The unfixed toner image transferred by the transfer device 45 is heated and/or pressed by the fixing device 61. The toner image is heated and/or pressed, and the toner image is thereby fixed to the recording medium P. As a result, the image is formed on the recording medium P. An example of the electrophotographic apparatus has been described; however, the electrophotographic apparatus is not limited to the electrophotographic apparatus 100 described above. The electrophotographic apparatus 100 described above is a color electrophotographic apparatus; alternatively, the electrophotographic apparatus may be a monochrome electrophotographic apparatus. In this case, the electrophotographic apparatus may include, for example, only a single image-forming unit.

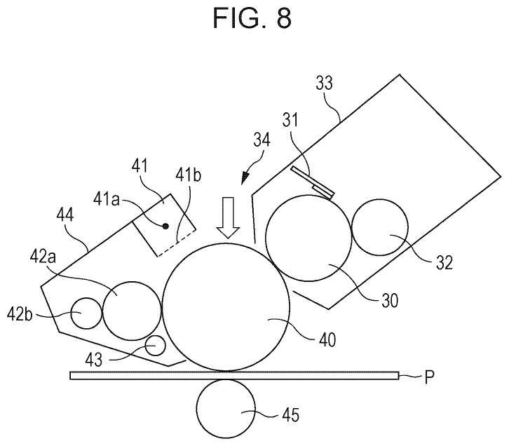

The charging device 41 is preferably a corona charging member configured to charge the electrophotographic photosensitive member 40 without contact with the electrophotographic photosensitive member 40, as illustrated in detail in FIG. 8. When the charging device is a corona charging member that employs a noncontact charging system, wear of the electrophotographic photosensitive member is reduced. The corona charging member 41 includes a charging control unit 41b configured to control a charging potential, and a discharge electrode 41a. A metal wiring line is preferably used as the discharge electrode 41a of the corona charging member. As the metal wiring line, a metal wire having a diameter of preferably 10 to 500 μm, more preferably 50 to 200 μm is used. The material of the metal wire may be tungsten, stainless steel, or the line optionally coated with a noble metal such as gold. Alternatively, a needle-shaped discharge electrode may be used as the discharge electrode 41a.

When a metal wire or a needle-shaped electrode is used as the discharge electrode 41a, the charging control unit 41b, such as a grid line to which a voltage is applied, is provided between the discharge electrode 41a and the electrophotographic photosensitive member 40 as in a scorotron charger, so that the charging potential of the electrophotographic photosensitive member 40 can be a desired value. Instead of the grid line, a thin plate made of a metal, such as SUS, and subjected to etching to cause an ion flow to pass through is also preferably used as the charging control unit 41b. In contrast, in a case of a corotron charger, the charging potential is controlled by the amount of current; however, this control tends to be insufficient. When a higher image quality is desired, the control tends to be difficult. Accordingly, scorotron charging is preferred.

The electrophotographic apparatus 100 described above employs the tandem system; alternatively, an electrophotographic apparatus may employ, for example, the rotary system. The electrophotographic apparatus 100 described above employs the contact developing system; alternatively, the electrophotographic apparatus may employ the noncontact developing system. The electrophotographic apparatus 100 described above employs the direct transfer system; alternatively, the electrophotographic apparatus may employ the intermediate transfer system. When the electrophotographic apparatus employs the intermediate transfer system, the member to be transferred corresponds to an intermediate transfer belt.

In the electrophotographic apparatus, the image-forming unit 50 may further include a cleaning member (for example, a cleaning blade). From the viewpoint of wear of the electrophotographic photosensitive member, preferably, a cleaning member configured to rub the surface of the electrophotographic photosensitive member to collect the toner adhering to the surface is not provided. The image-forming unit may further include a static elimination device.

### Process Cartridge

Next, an example of the process cartridge will be described with reference to FIG. 8. The process cartridge corresponds to each of the image-forming units 50a to 50d. The process cartridge includes an electrophotographic photosensitive member 40. The electrophotographic photosensitive member 40 is an image-carrying member. The process cartridge further includes, in addition to the electrophotographic photosensitive member 40, at least one selected from the group consisting of a charging device 41, an exposure device configured to irradiate the electrophotographic photosensitive member 40 with exposure light 34, a developing device 33, a transfer device 45, a pre-exposure device (static elimination device) 43, and a cleaning device. The developing device 33 includes a developing roller 30, a layer-forming blade 31, and a toner supplying roller 32. The cleaning device includes a cleaning roller 42a and a conductor 42b. However, for the reason described above, preferably, a cleaning member is not included. The process cartridge is designed so as to be attachable to and detachable from the electrophotographic apparatus 100. Therefore, the process cartridge is easy to handle and, when the sensitivity characteristics or the like of the electrophotographic photosensitive member 40 deteriorate, the process cartridge including the electrophotographic photosensitive member 40 can be easily and rapidly replaced. Reference numeral 44 denotes an electrophotographic photosensitive member unit (image-carrying member unit).

### EXAMPLES

The present disclosure is not limited at all by the following Examples without departing from the spirit and scope thereof. Note that, in the following description of Examples, “parts” are based on mass, unless otherwise specified.

### Production of Polyester Resins

### Synthesis of Resin (PAR-1)

A three-neck flask equipped with a thermometer, a three-way cock, and a dropping funnel was used as a reaction vessel.

First, the following materials were prepared.
Compound (BP-1) serving as a monomer (8.2 mmol)
Compound (BP-2) serving as a monomer (32.8 mmol)
2,6-Dimethylphenol (DMP) serving as an end termination agent (0.413 mmol)
Sodium hydroxide (98 mmol)
Benzyltributylammonium chloride (0.384 mmol)

These materials were placed in the reaction vessel, and the air in the reaction vessel was purged with argon gas. To the content of the reaction vessel, water (300 mL) was added. The content of the reaction vessel was stirred at 50° C. for one hour. The content of the reaction vessel was cooled to 10° C. to obtain an alkaline aqueous solution A.

Next, a dicarboxylic acid dichloride (20.8 mmol) of the compound (DC-1) serving as a monomer and a dicarboxylic acid dichloride (11.2 mmol) of the compound (DC-2) serving as a monomer were dissolved in chloroform (150 mL). Thus, a chloroform solution B was obtained.

To the alkaline aqueous solution A, the chloroform solution B was slowly added dropwise through the dropping funnel over 110 minutes. While the temperature (liquid temperature) of the content of the reaction vessel was adjusted to 15±5° C., the content of the reaction vessel was stirred for four hours to cause the polymerization reaction to proceed. The upper layer (aqueous layer) of the content of the reaction vessel was removed by decantation to obtain an organic layer. Subsequently, deionized water (400 mL) was added to an Erlenmeyer flask. The obtained organic layer was further added to the Erlenmeyer flask. Chloroform (400 mL) and acetic acid (2 mL) were further added to the Erlenmeyer flask. The content of the Erlenmeyer flask was stirred at room temperature (25° C.) for 30 minutes. The upper layer (aqueous layer) of the content of the Erlenmeyer flask was removed by decantation to obtain an organic layer. The obtained organic layer was washed with deionized water (1 L) using a separatory funnel. The washing with deionized water was repeated five times to obtain an organic layer washed with water. Subsequently, the organic layer washed with water was filtered to obtain a filtrate. The obtained filtrate was slowly added dropwise to methanol (1 L) to obtain a precipitate. The precipitate was collected by filtration. The collected precipitate was vacuum-dried at a temperature of 70° C. for 12 hours. As a result, a resin (PAR-1) having a viscosity-average molecular weight of 55,000 was obtained.

### Synthesis of Resins (PAR-2) to (PAR-25)

Resins (PAR-2) to (PAR-25) were synthesized by the same method as in the synthesis of the resin (PAR-1) except that the molar ratios of the bisphenols and the dicarboxylic acids were changed as shown in Table 1. Thus, the resins (PAR-2) to (PAR-25) having a viscosity-average molecular weight listed in Table 1 were obtained. Note that the viscosity-average molecular weights of the resins (PAR-2) to (PAR-25) were adjusted by changing the amount of end termination agent used. When the viscosity-average molecular weights of the resins (PAR-2) to (PAR-25) were increased, the amount of end termination agent used was decreased.

TABLE 1

| | Bisphenol | | Dicarboxylic acid | | End termination | Molecular |
|---|---|---|---|---|---|---|
| Resin | BP-1 | BP-2 | DC-1 | DC-2 | agent | weight |
| PAR-1 | 20 | 80 | 65 | 35 | DMP | 52000 |
| PAR-2 | 20 | 80 | 55 | 45 | DMP | 53000 |
| PAR-3 | 20 | 80 | 50 | 50 | DMP | 52700 |
| PAR-4 | 20 | 80 | 45 | 55 | DMP | 58000 |
| PAR-5 | 35 | 65 | 30 | 70 | DMP | 54300 |
| PAR-6 | 35 | 65 | 65 | 35 | DMP | 60000 |
| PAR-7 | 35 | 65 | 70 | 30 | DMP | 51000 |
| PAR-8 | 35 | 65 | 75 | 25 | DMP | 51000 |
| PAR-9 | 50 | 50 | 95 | 5 | DMP | 57000 |
| PAR-10 | 50 | 50 | 90 | 10 | DMP | 55000 |
| PAR-11 | 50 | 50 | 70 | 30 | DMP | 56000 |
| PAR-12 | 50 | 50 | 50 | 50 | DMP | 57000 |
| PAR-13 | 50 | 50 | 45 | 55 | DMP | 58000 |
| PAR-14 | 50 | 50 | 40 | 60 | DMP | 61000 |
| PAR-15 | 50 | 50 | 20 | 80 | DMP | 52000 |
| PAR-16 | 100 | 0 | 100 | 0 | DMP | 13000 |
| PAR-17 | 100 | 0 | 100 | 0 | DMP | 35000 |
| PAR-18 | 100 | 0 | 100 | 0 | DMP | 55000 |
| PAR-19 | 100 | 0 | 100 | 0 | DMP | 66000 |
| PAR-20 | 100 | 0 | 100 | 0 | DMP | 78000 |
| PAR-21 | 100 | 0 | 65 | 35 | DMP | 52000 |
| PAR-22 | 20 | 80 | 100 | 0 | DMP | 58000 |
| PAR-23 | 0 | 100 | 0 | 100 | DMP | 68000 |
| PAR-24 | 0 | 100 | 65 | 35 | DMP | 60000 |
| PAR-25 | 20 | 80 | 0 | 100 | DMP | 65000 |

The numerical values in Bisphenol in Table 1 denote the molar ratio (percentage) of the amount of substance of a bisphenol to the total amount of substance of the compound (BP-1) and the compound (BP-2). The numerical values in Dicarboxylic acid in Table 1 denote the molar ratio (percentage) of the amount of substance of a dicarboxylic acid to the total amount of substance of the compound (DC-1) and the compound (DC-2). The molecular weight denotes the viscosity-average molecular weight.

### Example 1

### Production of Electrophotographic Photosensitive Member

### Production of Photosensitive Member 1

An aluminum cylinder (JIS-A3003, aluminum alloy) having a length of 260.5 mm and a diameter of 30 mm was cut (JIS B0601: 2014, ten-point average roughness Rzjis: 0.8 μm) and used as a conductive support.

The following materials were prepared.
Y-type titanyl phthalocyanine (CGM-1) serving as a charge generation material: 10.0 parts by mass
Hole transport material (H-1): 63.0 parts by mass
Hole transport material (4): 7.0 parts by mass
Electron transport material (E-4): 35.0 parts by mass
Polyester resin (PAR-1) serving as a binder resin: 100.0 parts by mass
Additive (T-1): 1.6 parts by mass
Tetrahydrofuran serving as a solvent: 500.0 parts by mass

The above-described materials were mixed for 20 minutes using a rod-type sound-wave transducer to obtain a dispersion liquid. The dispersion liquid was filtered through a filter having an opening of 5 μm to obtain a photosensitive layer-forming coating liquid. The photosensitive layer-forming coating liquid was applied to the conductive support by the dip coating method and dried in hot air at 120° C. for 50 minutes. In this manner, a photosensitive layer (layer thickness: 30 μm) was formed on the conductive support and left to stand in an environment at a temperature of 23° C. and a humidity of 50% RH for 72 hours to obtain a photosensitive member 1.

### Analysis of Resin Component of Photosensitive Member 1

The polymer component recovered from the obtained photosensitive member was subjected to ¹H-nuclear magnetic resonance analysis in deuterated chloroform to obtain a ¹H-NMR spectrum. The ¹H-NMR spectrum had peaks at 8.22±0.02 ppm, 7.18±0.02 ppm, 7.16±0.02 ppm, 7.10±0.02 ppm, 7.06±0.02 ppm, 7.04±0.02 ppm, 2.28±0.02 ppm, 2.20±0.02 ppm, 1.59±0.02 ppm, and 1.54±0.02 ppm. Thus, the photosensitive member was specified to include structural units represented by formulas (P-1), (P-2), (P-3), and (P-4). Furthermore, the ratios of the amounts of substances of the structural units represented by formula (P-1), formula (P-2), formula (P-3), and formula (P-4) were confirmed to be as shown in Table 1 based on the integral ratio of the above peaks.

### Evaluation

For the photosensitive member (single-layer photosensitive member), ghosting and wear resistance were evaluated by the methods described below.

An electrophotographic apparatus used was a modified machine obtained by modifying a monochrome laser printer (trade name: HL-6400, manufactured by Brother Industries, Ltd.). As a power supply for supplying the power for a corona charger from the outside of the printer, a high-voltage power supply control system (trade name: Model 615-3, manufactured by TREK, INC.) was used. An electrophotographic photosensitive member of a drum unit in a cartridge for this printer was removed, and the electrophotographic photosensitive member 1 was installed instead.

An example in which the monochrome laser printer (trade name: HL-6400, manufactured by Brother Industries, Ltd.) is used as an evaluation machine will be described below; however, advantageous effects according to the present disclosure can also be confirmed in a monochrome laser printer (trade name: HL-L2325, manufactured by Brother Industries, Ltd.). These evaluation machines do not include a cleaning member configured to rub the surface of an electrophotographic photosensitive member to collect a toner adhering to the surface.

### Evaluation of Ghost

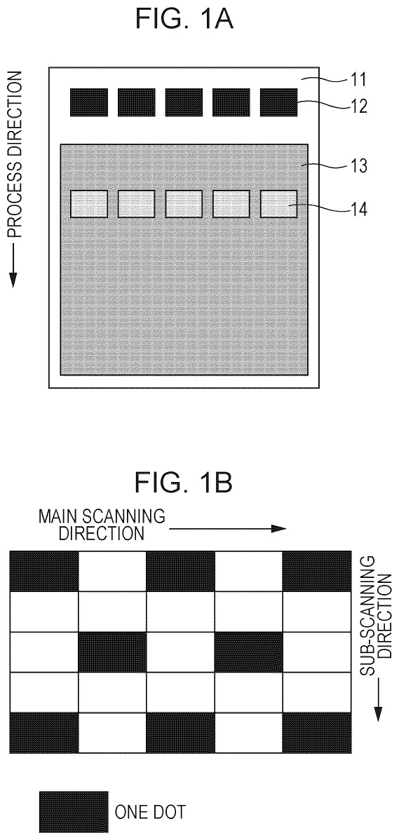

In a state where a pre-exposure device was shielded from light, one sheet of a white solid image was output as the first sheet. Subsequently, printing for ghost evaluation was performed. Specifically, a series of images having an image with a black background (black image) 12 in a white background (white image) 11 in an image leading end portion as illustrated in FIG. 1A and a subsequent halftone image 13 of the similar knight jump pattern illustrated in FIG. 1B was continuously output on five sheets. In FIG. 1A, “ghost portions 14” are portions used to evaluate the occurrence or non-occurrence of ghosting due to the black background (black image) 12.

Ghosting was evaluated by measuring, in the above printing for ghost evaluation, the difference between the image density of the halftone image 13 of the similar knight jump pattern and the image density of a ghost portion 14 with a spectrodensitometer (trade name: X-Rite 504/508, manufactured by X-Rite Inc.). The image density was measured at 10 points for each of the halftone image 13 and the ghost portion 14 in the printing for ghost evaluation, and the average of the image densities measured at the 10 points was calculated. The same measurement was performed on all of the five sheets of the printing for ghost evaluation. The density difference between the average of the image density for the halftone image 13 and the average of the image density for the ghost portion 14 was defined as a ghost image density difference. A smaller ghost image density difference means that a higher effect of reducing the occurrence of ghosting is obtained.

Ghosting was evaluated on the basis of the following criteria. A ghost image density difference of less than 0.01 is evaluated as A. A ghost image density difference of 0.01 or more and less than 0.02 is evaluated as B. A ghost image density difference of 0.02 or more and less than 0.03 is evaluated as C. A ghost image density difference of 0.03 or more and less than 0.04 is evaluated as D. A ghost image density difference of 0.04 or more is evaluated as E. The evaluation results are shown in Table 2.

### Evaluation of Wear Resistance

First, a print test was performed. The print test was a test in which a print pattern image with a printing ratio of 3% was printed on 10,000 sheets of recording media (A4 size) using the evaluation machine. Next, the electrophotographic photosensitive member 1 was taken out from the drum unit of the cartridge used in the print test. Subsequently, an electrophotographic photosensitive member was removed from a drum unit of a new cartridge, and the electrophotographic photosensitive member 1 was installed. The cartridge including the electrophotographic photosensitive member 1 was installed in the evaluation machine, and a halftone image of the similar knight jump pattern was output at a different density.

Wear resistance was evaluated on the basis of the following criteria. For the surface layer thickness of the electrophotographic photosensitive member 1, the amount of decrease (amount of scraping) from the initial thickness was measured at intervals of 1 mm in the longitudinal direction, and the maximum value of the amount of decrease in the longitudinal direction was evaluated as wear resistance. In this evaluation, the layer thickness was measured using a film thickness meter Fischer MMS eddy-current probe EAW3.3, manufactured by Fischer Instruments K.K. The evaluation results are shown in Table 2.

### Examples 2 to 39 and Comparative Examples 1 to 6

Electrophotographic photosensitive members were produced and evaluated as in Example 1 except that the types and the amounts of binder resin, hole transport materials, electron transport material, charge generation material, and additive mixed in the photosensitive layer-forming coating liquid were changed as shown in Table 2. The results are shown in Table 2.

The hole transport material HR-1 in Table 2 is a compound represented by formula (HR-1) below.

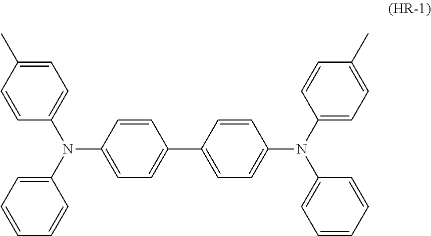 [SMILES: Cc1ccc(N(c2ccccc2)c2ccc(-c3ccc(N(c4ccccc4)c4ccc(C)cc4)cc3)cc2)cc1]

In Example 38, the charger was modified as described below, and the evaluation of ghosting and the evaluation of wear resistance were performed.

First, the scorotron charger was removed. A charging roller taken out from ECOSYS P5026cdw manufactured by KYOCERA Corporation was additionally processed and modified so as to be installed, and installed instead. In addition, the output of the external power supply was adjusted so that the image density was not changed by the change in the charger.

In the evaluation of ghosting and the evaluation of wear resistance in Example 39, the toner (average circularity: 0.980) was taken out from the cartridge, and a toner (average circularity: 0.958) taken out from a toner cartridge (TN32JXL) manufactured by Brother Industries, Ltd. was used instead.

TABLE 2

| | | | | | | | | | Ratio of | | | |
|---|---|---|---|---|---|---|---|---|---|---|---|---|
| | | | | | | | | | hole | | | |
| | | | | | | | | | transport | | | |
| | | | | | | | | | material | Ratio of | | |
| | | | Electron | | | | | | (2) to hole | hole | | Wear |
| | Electrophotographic | | transport | | Hole transport materials | | | | transport | transport | | resistance |
| | photosensitive | | material | | (1) | | (2) | | material | materials | Ghost | evaluation |
| | member No. | Resin | Type | parts | Type | parts | Type | parts | (1) | to resin | evaluation | (μm) |
| Example 1 | Electrophotographic | PAR-1 | E-4 | 35.0 | H-1 | 63.0 | H-2 | 7.0 | 11% | 70% | A | 1.5 |
| | photosensitive member 1 | | | | | | | | | | | |
| Example 2 | Electrophotographic | PAR-2 | E-4 | 35.0 | H-1 | 63.0 | H-2 | 7.0 | 11% | 70% | A | 1.6 |
| | photosensitive member 2 | | | | | | | | | | | |
| Example 3 | Electrophotographic | PAR-3 | E-4 | 35.0 | H-1 | 63.0 | H-2 | 7.0 | 11% | 70% | A | 1.7 |
| | photosensitive member 3 | | | | | | | | | | | |
| Example 4 | Electrophotographic | PAR-4 | E-4 | 35.0 | H-1 | 63.0 | H-2 | 7.0 | 11% | 70% | A | 1.9 |
| | photosensitive member 4 | | | | | | | | | | | |
| Example 5 | Electrophotographic | PAR-5 | E-4 | 35.0 | H-1 | 63.0 | H-2 | 7.0 | 11% | 70% | A | 1.9 |
| | photosensitive member 5 | | | | | | | | | | | |
| Example 6 | Electrophotographic | PAR-6 | E-4 | 35.0 | H-1 | 63.0 | H-2 | 7.0 | 11% | 70% | A | 1.4 |
| | photosensitive member 6 | | | | | | | | | | | |
| Example 7 | Electrophotographic | PAR-7 | E-4 | 35.0 | H-1 | 63.0 | H-2 | 7.0 | 11% | 70% | A | 1.2 |
| | photosensitive member 7 | | | | | | | | | | | |
| Example 8 | Electrophotographic | PAR-8 | E-4 | 35.0 | H-1 | 63.0 | H-2 | 7.0 | 11% | 70% | A | 1.0 |
| | photosensitive member 8 | | | | | | | | | | | |
| Example 9 | Electrophotographic | PAR-9 | E-4 | 35.0 | H-1 | 63.0 | H-2 | 7.0 | 11% | 70% | B | 1.3 |
| | photosensitive member 9 | | | | | | | | | | | |
| Example 10 | Electrophotographic | PAR-10 | E-4 | 35.0 | H-1 | 63.0 | H-2 | 7.0 | 11% | 70% | A | 1.0 |
| | photosensitive member 10 | | | | | | | | | | | |
| Example 11 | Electrophotographic | PAR-11 | E-4 | 35.0 | H-1 | 63.0 | H-2 | 7.0 | 11% | 70% | A | 1.1 |
| | photosensitive member 11 | | | | | | | | | | | |
| Example 12 | Electrophotographic | PAR-12 | E-4 | 35.0 | H-1 | 63.0 | H-2 | 7.0 | 11% | 70% | A | 1.2 |
| | photosensitive member 12 | | | | | | | | | | | |
| Example 13 | Electrophotographic | PAR-13 | E-4 | 35.0 | H-1 | 63.0 | H-2 | 7.0 | 11% | 70% | A | 1.5 |
| | photosensitive member 13 | | | | | | | | | | | |
| Example 14 | Electrophotographic | PAR-14 | E-4 | 35.0 | H-1 | 63.0 | H-2 | 7.0 | 11% | 70% | A | 1.7 |
| | photosensitive member 14 | | | | | | | | | | | |
| Example 15 | Electrophotographic | PAR-15 | E-4 | 35.0 | H-1 | 63.0 | H-2 | 7.0 | 11% | 70% | A | 2.0 |
| | photosensitive member 15 | | | | | | | | | | | |
| Example 16 | Electrophotographic | PAR-16 | E-4 | 35.0 | H-1 | 63.0 | H-2 | 7.0 | 11% | 70% | B | 1.5 |
| | photosensitive member 16 | | | | | | | | | | | |
| Example 17 | Electrophotographic | PAR-17 | E-4 | 35.0 | H-1 | 63.0 | H-2 | 7.0 | 11% | 70% | B | 1.0 |
| | photosensitive member 17 | | | | | | | | | | | |
| Example 18 | Electrophotographic | PAR-18 | E-4 | 35.0 | H-1 | 63.0 | H-2 | 7.0 | 11% | 70% | B | 0.9 |
| | photosensitive member 18 | | | | | | | | | | | |
| Example 19 | Electrophotographic | PAR-19 | E-4 | 35.0 | H-1 | 63.0 | H-2 | 7.0 | 11% | 70% | B | 0.9 |
| | photosensitive member 19 | | | | | | | | | | | |
| Example 20 | Electrophotographic | PAR-20 | E-4 | 35.0 | H-1 | 63.0 | H-2 | 7.0 | 11% | 70% | C | 0.8 |
| | photosensitive member 20 | | | | | | | | | | | |
| Example 21 | Electrophotographic | PAR-21 | E-4 | 35.0 | H-1 | 63.0 | H-2 | 7.0 | 11% | 70% | A | 1.1 |
| | photosensitive member 21 | | | | | | | | | | | |
| Example 22 | Electrophotographic | PAR-22 | E-4 | 35.0 | H-1 | 63.0 | H-2 | 7.0 | 11% | 70% | B | 1.5 |
| | photosensitive member 22 | | | | | | | | | | | |
| Example 23 | Electrophotographic | PAR-1 | E-4 | 35.0 | H-1 | 85.5 | H-2 | 9.5 | 11% | 95% | A | 1.7 |
| | photosensitive member 23 | | | | | | | | | | | |
| Example 24 | Electrophotographic | PAR-1 | E-4 | 35.0 | H-1 | 81.0 | H-2 | 9.0 | 11% | 90% | A | 1.6 |
| | photosensitive member 24 | | | | | | | | | | | |
| Example 25 | Electrophotographic | PAR-1 | E-4 | 35.0 | H-1 | 45.0 | H-2 | 5.0 | 11% | 50% | B | 1.5 |
| | photosensitive member 25 | | | | | | | | | | | |
| Example 26 | Electrophotographic | PAR-1 | E-4 | 35.0 | H-1 | 40.5 | H-2 | 4.5 | 11% | 45% | C | 1.4 |
| | photosensitive member 26 | | | | | | | | | | | |
| Example 27 | Electrophotographic | PAR-1 | E-4 | 35.0 | H-1 | 68.0 | H-2 | 2.0 | 3% | 70% | C | 1.2 |
| | photosensitive member 27 | | | | | | | | | | | |
| Example 28 | Electrophotographic | PAR-1 | E-4 | 35.0 | H-1 | 66.7 | H-2 | 3.3 | 5% | 70% | B | 1.3 |
| | photosensitive member 28 | | | | | | | | | | | |
| Example 29 | Electrophotographic | PAR-1 | E-4 | 35.0 | H-1 | 46.7 | H-2 | 23.3 | 50% | 70% | A | 1.8 |
| | photosensitive member 29 | | | | | | | | | | | |
| Example 30 | Electrophotographic | PAR-1 | E-4 | 35.0 | H-1 | 45.2 | H-2 | 24.8 | 55% | 70% | A | 2.0 |
| | photosensitive member 30 | | | | | | | | | | | |
| Example 31 | Electrophotographic | PAR-1 | E-1 | 35.0 | H-1 | 63.0 | H-2 | 7.0 | 11% | 70% | A | 1.7 |
| | photosensitive member 31 | | | | | | | | | | | |
| Example 32 | Electrophotographic | PAR-1 | E-2 | 35.0 | H-1 | 63.0 | H-2 | 7.0 | 11% | 70% | A | 1.6 |
| | photosensitive member 32 | | | | | | | | | | | |
| Example 33 | Electrophotographic | PAR-1 | E-3 | 35.0 | H-1 | 63.0 | H-2 | 7.0 | 11% | 70% | A | 1.5 |
| | photosensitive member 33 | | | | | | | | | | | |
| Example 34 | Electrophotographic | PAR-1 | E-5 | 35.0 | H-1 | 63.0 | H-2 | 7.0 | 11% | 70% | A | 1.9 |
| | photosensitive member 34 | | | | | | | | | | | |
| Example 35 | Electrophotographic | PAR-1 | E-6 | 35.0 | H-1 | 63.0 | H-2 | 7.0 | 11% | 70% | A | 1.8 |
| | photosensitive member 35 | | | | | | | | | | | |
| Example 36 | Electrophotographic | PAR-1 | E-7 | 35.0 | H-1 | 63.0 | H-2 | 7.0 | 11% | 70% | A | 1.6 |
| | photosensitive member 36 | | | | | | | | | | | |
| Example 37 | Electrophotographic | PAR-1 | E-8 | 35.0 | H-1 | 63.0 | H-2 | 7.0 | 11% | 70% | A | 1.9 |
| | photosensitive member 37 | | | | | | | | | | | |
| Example 38 | Electrophotographic | PAR-1 | E-4 | 35.0 | H-1 | 63.0 | H-2 | 7.0 | 11% | 70% | A | 1.9 |
| | photosensitive member 1 | | | | | | | | | | | |
| Example 39 | Electrophotographic | PAR-1 | E-4 | 35.0 | H-1 | 63.0 | H-2 | 7.0 | 11% | 70% | A | 1.5 |
| | photosensitive member 1 | | | | | | | | | | | |
| Comparative | Electrophotographic | PAR-1 | E-4 | 35.0 | H-1 | 70.0 | H-2 | 0.0 | 0% | 70% | E | 1.4 |
| Example 1 | photosensitive member 38 | | | | | | | | | | | |
| Comparative | Electrophotographic | PAR-1 | E-4 | 35.0 | H-1 | 0.0 | H-2 | 70.0 | — | 70% | C | 2.5 |
| Example 2 | photosensitive member 39 | | | | | | | | | | | |
| Comparative | Electrophotographic | PAR-1 | E-4 | 35.0 | H-1 | 63.0 | HR-1 | 7.0 | 11% | 70% | D | 1.5 |
| Example 3 | photosensitive member 40 | | | | | | | | | | | |
| Comparative | Electrophotographic | PAR-23 | E-4 | 35.0 | H-1 | 63.0 | H-2 | 7.0 | 11% | 70% | A | 2.9 |
| Example 4 | photosensitive member 42 | | | | | | | | | | | |
| Comparative | Electrophotographic | PAR-24 | E-4 | 35.0 | H-1 | 63.0 | H-2 | 7.0 | 11% | 70% | A | 2.2 |
| Example 5 | photosensitive member 43 | | | | | | | | | | | |
| Comparative | Electrophotographic | PAR-25 | E-4 | 35.0 | H-1 | 63.0 | H-2 | 7.0 | 11% | 70% | A | 2.5 |
| Example 6 | photosensitive member 44 | | | | | | | | | | | |

The present disclosure can provide an electrophotographic photosensitive member capable of reducing the occurrence of ghosting while having good wear resistance.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-033148, filed Mar. 3, 2025, which is hereby incorporated by reference herein in its entirety.

What is claimed is:

1. An electrophotographic photosensitive member comprising:
a support; and
a photosensitive layer,
wherein the photosensitive layer contains a charge generation material, a binder resin, and a hole transport material,
the binder resin contains a polyester resin having a structural unit represented by formula (P-1) and a structural unit represented by formula (P-2), and
the hole transport material includes a compound represented by formula (3) and a compound represented by formula (4): 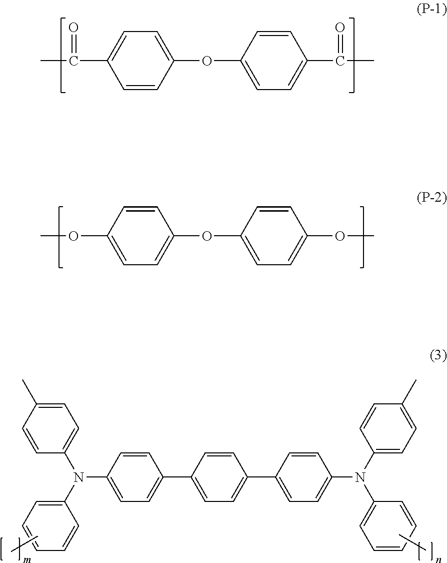
in formula (3), m and n each independently represent an integer of 0, 1, or 2,

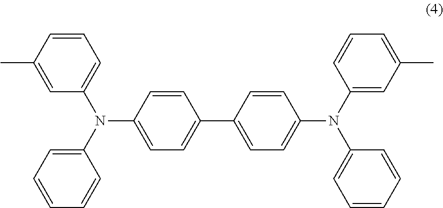

2. The electrophotographic photosensitive member according to claim 1, wherein the polyester resin further has a structural unit represented by formula (P-3) and a structural unit represented by formula (P-4):

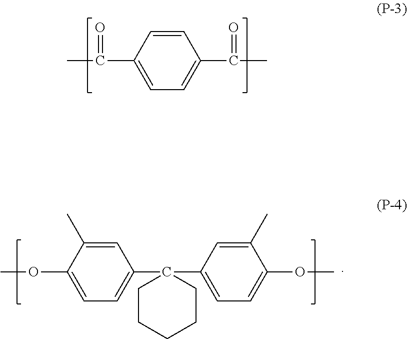

3. The electrophotographic photosensitive member according to claim 1, wherein when a content of the binder resin is 100 parts by mass, a total content of the compound represented by formula (3) and the compound represented by formula (4) is 50 parts by mass or more and 90 parts by mass or less relative to 100 parts by mass of the binder resin.

4. The electrophotographic photosensitive member according to claim 1, wherein a ratio of a content of the compound represented by formula (4) to a content of the compound represented by formula (3) is 0.05 or more and 0.50 or less.

5. The electrophotographic photosensitive member according to claim 1, wherein when a total amount of substance of a structural unit represented by formula (a) and constituting the polyester resin is defined as MC, and an amount of substance of the structural unit represented by formula (P-1) is defined as M1, 0.90≥M1/MC≥0.50 is satisfied, 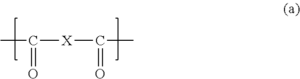
in formula (a), X represents a divalent organic group.

6. The electrophotographic photosensitive member according to claim 5, wherein when the total amount of substance of the structural unit represented by formula (a) and constituting the polyester resin is defined as MC, and the amount of substance of the structural unit represented by formula (P-1) is defined as M1, 0.90≥M1/MC≥0.70 is satisfied.

7. A process cartridge comprising:
an electrophotographic photosensitive member; and
at least one device selected from the group consisting of a charging device, an exposure device, a developing device, and a cleaning device, the process cartridge integrally supporting the electrophotographic photosensitive member and the at least one device and being attachable to and detachable from a main body of an electrophotographic apparatus,
wherein the electrophotographic photosensitive member includes a support and a photosensitive layer,
the photosensitive layer contains a charge generation material, a binder resin, and a hole transport material,
the binder resin contains a polyester resin having a structural unit represented by formula (P-1) and a structural unit represented by formula (P-2), and
the hole transport material includes a compound represented by formula (3) and a compound represented by formula (4): 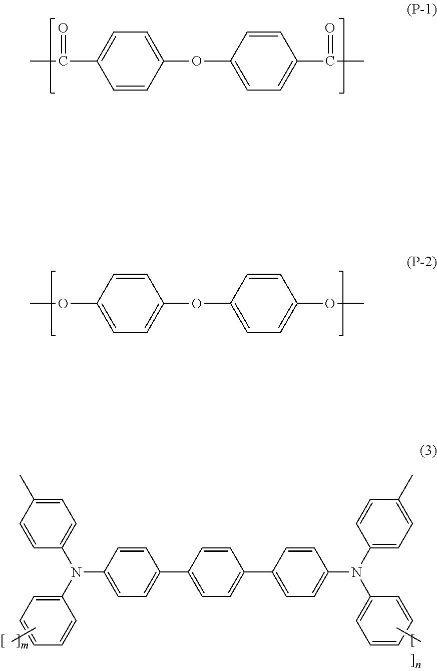
in formula (3), m and n each independently represent an integer of 0, 1, or 2,

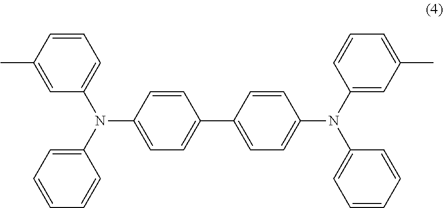

8. An electrophotographic apparatus comprising:
an electrophotographic photosensitive member;
a charging device;
an exposure device;
a developing device; and
a transfer device,
wherein the electrophotographic photosensitive member includes a support and a photosensitive layer,
the photosensitive layer contains a charge generation material, a binder resin, and a hole transport material,
the binder resin contains a polyester resin having a structural unit represented by formula (P-1) and a structural unit represented by formula (P-2), and
the hole transport material includes a compound represented by formula (3) and a compound represented by formula (4): 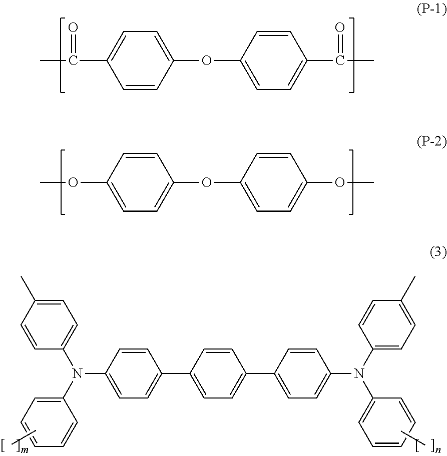
in formula (3), m and n each independently represent an integer of 0, 1, or 2,

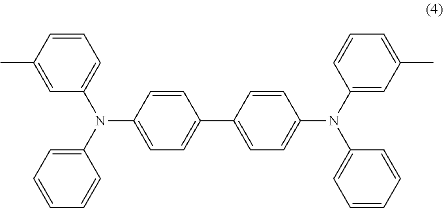

9. The electrophotographic apparatus according to claim 8, wherein the developing device includes a toner having an average circularity of 0.960 or less.

10. The electrophotographic apparatus according to claim 8, wherein the developing device includes a toner having an average circularity of 0.975 or more.

11. The electrophotographic apparatus according to claim 8, wherein the charging device is a scorotron charger including a discharge electrode and a grid.

12. The electrophotographic apparatus according to claim 8, wherein the electrophotographic apparatus does not include a cleaning member configured to rub a surface of the electrophotographic photosensitive member to collect a toner adhering to the surface of the electrophotographic photosensitive member.
